(19) United States
(12) Patent Application Publication
(10) Pub. No.: US 2020/0044702 A1
(43) Pub. Date: Feb. 6, 2020

(54) USER EQUIPMENT AND BASE STATION

(71) Applicant: NTT DOCOMO, INC., Tokyo (JP)

(72) Inventors: Yuichi Kakishima, Tokyo (JP); Chongning Na, Tokyo (JP); Huiling Li, Tokyo (JP); Huiling Jiang, Tokyo (JP); Satoshi Nagata, Tokyo (JP)

(73) Assignee: NTT DOCOMO, INC., Tokyo (JP)

(21) Appl. No.: 16/496,771

(22) PCT Filed: Mar. 22, 2018
(86) PCT No.: PCT/US2018/023792

§ 371 Date: Sep. 23, 2019

Related U.S. Application Data
(60) Provisional application No. 62/475,629, filed on Mar. 23, 2017.

(51) Int. Cl. H04B 7/0456; H04B 7/06; H04L 5/00

(52) U.S. Cl. CPC H04B 7/0478; H04B 7/0626; H04L 5/0051; H04B 7/0617; H04B 7/0639

(57) ABSTRACT

A user equipment (UE) is disclosed including a receiver that receives, from a base station (BS), Channel State Information-Reference Signals (CSI-RSs) using a plurality of first beams. The UE further includes a processor that selects a first matrix W1 from a first codebook and a second matrix W2 from a second codebook, and selects second beams from the plurality of first beams. The UE further includes a transmitter that performs CSI reporting that includes precoding matrix indicators (PMIs) corresponding to the W1 and W2. The W1 indicates a plurality of sets of the second beams in each of a first layer and a second layer. The plurality of sets adjacent to each other are orthogonal. The W2 indicates a combination of same beams between the first layer and the second layer.

### TECHNICAL FIELD

One or more embodiments disclosed herein relates to design of codebook that consists of precoder vectors used for beamforming in a wireless communication system including a user equipment and a base station which a beam is equivalent to a precoder vector.

### BACKGROUND

In Rel. 13 Long Term Evolution (LTE), codebook design for rank 2 (rank 2 codebook design) has much in common with codebook for rank 1 (rank 1 codebook design). For example, rank 1 codebook design and the rank 2 codebook design share the same beam pattern which is indicated by Codebook-Config from an evolved NodeB (eNB) to a user equipment (UE). A difference between rank 1 codebook design and rank 2 codebook design is that rank 2 transmission needs a beam combination for two layers. For both rank 1 and rank 2 codebook design, the beam patterns are adapted to different scenarios and are chosen by eNB. The beam pattern will impact performance because the beam pattern will fix coverage of the beams. In Rel. 13 LTE, the beam selection for both layer 1 and layer 2 should be within some given beam patterns. As a result, beam pattern design may impact the performance.

As described above, the beam pattern design for rank 2 in Rel. 13 LTE has in common with the beam pattern design for rank 1 and the beam spacing for active beams (beams that can be chosen by W2) within the beam pattern is 1, which means that the beams for two layers are not orthogonal if co-phase is not considered.

Further, rank 2 codebook design (e.g., beam pattern and beam selection granularity (wideband or subband) for New Radio has not been determined.

### CITATION LIST

### Non-Patent Reference

[Non-Patent Reference 1] 3GPP, TS 36.211 V 14.1.0
[Non-Patent Reference 2] 3GPP, TS 36.213 V14.1.0

### SUMMARY

In accordance with embodiments of the present invention, a user equipment (UE) in a in a wireless communication system includes a receiver that receives, from a base station (BS), Channel State Information-Reference Signals (CSI-RSs) using a plurality of first beams, a processor that selects a first matrix W1 from a first codebook and a second matrix W2 from a second codebook, and selects second beams from the plurality of first beams, and a transmitter that performs CSI reporting that includes precoding matrix indicators (PMIs) corresponding to the W1 and W2. The W1 indicates a plurality of sets of the second beams in each of a first layer and a second layer, The plurality of sets adjacent to each other are orthogonal. The W2 indicates a combination of same beams between the first layer and the second layer.

In accordance with embodiments of the present invention, a base station (BS) in a in a wireless communication system includes a transmitter that transmits, to a user equipment (UE), Channel State Information-Reference Signals (CSI-RSs) using a plurality of first beams, a receiver that receives CSI reporting that includes precoding matrix indicators (PMIs) corresponding to a first matrix W1 selected from a first codebook and a second matrix W2 selected from a second codebook the W1 and W2. The transmits a downlink signal precoded using the PMIs. The W1 indicates a plurality of sets of second beams in each of a first layer and a second layer. The second beams are selected from the plurality of first beams. The plurality of sets adjacent to each other are orthogonal. The W2 indicates a combination of same beams between the first layer and the second layer.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2 is a sequence diagram showing an example operation of codebook based beam selection according to one or more embodiments of the present invention.

FIG. 3 is a diagram showing an example of beam patterns according to one or more embodiments of the present invention.

FIG. 4 is a schematic diagram showing an example of beam selection using a codebook for rank 2 according to one or more embodiments of the present invention.

FIG. 5 is a diagram showing an example of W1 design for rank 2 according to one or more embodiments of the present invention.

FIG. 6 is a diagram showing an example of W2 design for rank 2 according to one or more embodiments of the present invention.

FIGS. 7A-7E are diagrams showing examples of beam combinations for W2 for selection according to one or more embodiments of the present invention.

FIG. 8 is a diagram showing an example of beam combination selection by W1W2 according to one or more embodiments of the present invention.

FIG. 9 is a diagram showing an example of 8 beams in W1 and 8 combinations for W2 for selection according to one or more embodiments of the present invention.

FIGS. 10A and 10B are diagrams showing examples of 12 beams in W1 and 12 combinations for W2 for selection according to one or more embodiments of the present invention.

FIG. 11 is a diagram showing an example of beam combinations according to one or more embodiments of the present invention.

FIG. 12 is a diagram showing another example of beam combinations according to one or more embodiments of the present invention.

FIG. 13 is a diagram showing an example of W1 design for rank 2 according to one or more embodiments of the present invention.

FIG. 14 is a diagram showing an example of W2 design for rank 2 according to one or more embodiments of the present invention.

FIG. 15 is a diagram showing a schematic configuration of a base station (BS) according to one or more embodiments of the present invention.

FIG. 16 is a diagram showing a schematic configuration of a user equipment (UE) according to one or more embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

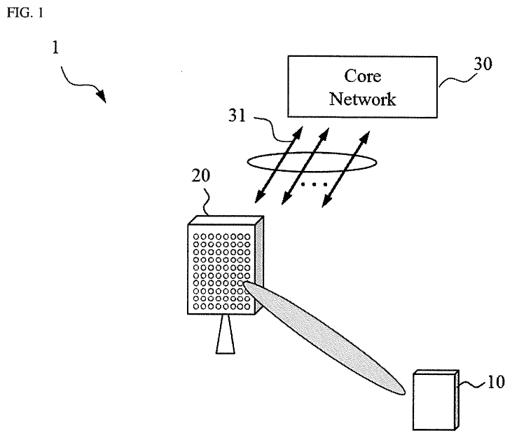

FIG. 1 is a wireless communications system 1 according to one or more embodiments of the present invention. The wireless communication system 1 includes a user equipment (UE) 10, a base station (BS) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB).

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

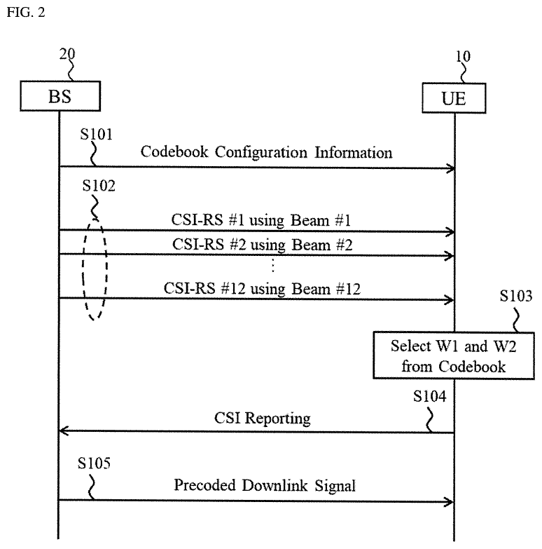

FIG. 2 is a sequence diagram showing an example operation of codebook based beam selection according to one or more embodiments of the present invention.

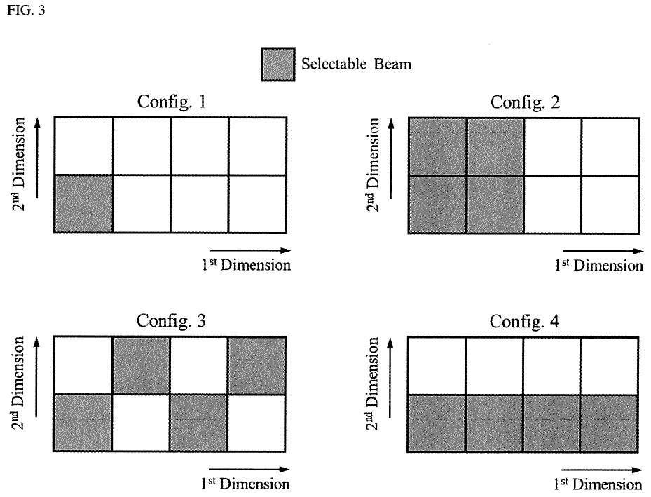

As shown in FIG. 2, at step S101, the BS 20 transmits codebook configuration information to the UE 10. The codebook configuration information indicates a beam pattern. FIG. 3 shows an example of beam patterns according to one or more embodiments of the present invention. As shown in FIG. 3, for example, the beam patterns have four patterns such as Configs. 1-4. The beam pattern designates locations of selectable beams in a first dimension (e.g., vertical direction) and a second dimension (e.g., horizontal direction). The beam patterns is not limited to four patterns such as Configs. 1-4. The beam patterns according to one or more embodiments may be predetermined patterns.

Turning back to FIG. 2, at step S102, the BS 20 transmits multiple Channel State Information-Reference Signals (CSI-RSs) using beams. For example, each of CSI-RSs #1-12 is transmitted using each of beams #1-12.

At step S103, the UE 10 selects, from the beams used for the CSI-RSs transmission, candidate beams based on reception quality (e.g., Reference Signal Received Power (RSRP)) and selects a codebook matrix W1 from a first codebook and a codebook matrix W2 from a second codebook. The codebook matrix may be referred to as a precoding matrix. Codebook design according to one or more embodiments may apply dual-stage codebook design. In the dual-stage codebook design, a codebook matrix W is indicated as a product of W1 and W2 (W=W1W2). W1 may indicate candidate beams for further selection. W2 may indicate at least a beam. The codebook design for rank 2 according to one or more embodiments will be described below in detail.

At step S104, the UE performs CSI reporting. The CSI reporting includes Precoding Matrix Indicators (PMIs) corresponding to W1 and W2. Further, the CSI reporting may include a Rank Indicator (RI), a Beam Index (BI), a Channel Quality Indicator (CQI), and an RSRP. The BI may be referred to as CSI-RS Resource Indicator (CRI).

At step S105, the BS 20 performs precoding for a downlink signal(s) to be transmitted using the received PMIs (W1 and W2) and transmits the precoded downlink signal to the UE 10.

The Codebook for rank 2 according to one or more embodiments will be described below.

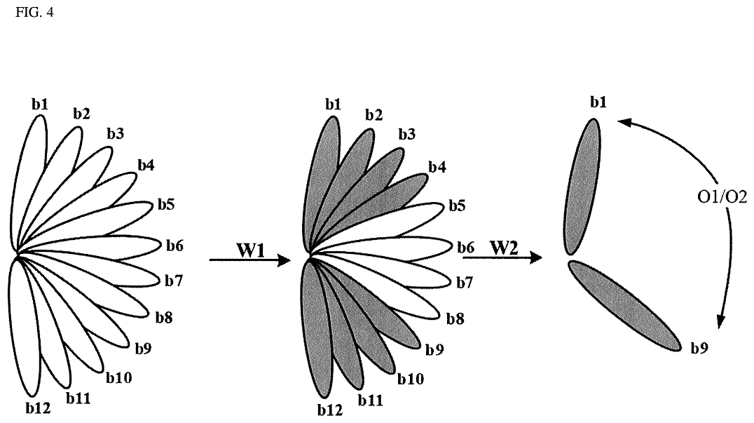

FIG. 4 is a schematic diagram showing an example of beam selection using the codebook for rank 2 according to one or more embodiments of the present invention. In an example of FIG. 4, beams may be selected from 12 beams (b1, b2, . . . , b12) used for CSI-RS transmission from the BS 20.

As shown in FIG. 4, W1 is used to select beams (e.g., b1-b4 and b9-b12) from multiple beams (e.g., b1-b12) using the beam pattern. For example, two or more beams of the selected beams are orthogonal to each other. W2 is used to further select a beam combination (e.g. b1 and b9) from all of beam combinations and add co-phase between polarizations of the beams in the selected beam combination.

In examples as explained below, a beam pattern used for beam selection may be Config. 2 may be applied as a beam pattern as shown in FIG. 3.

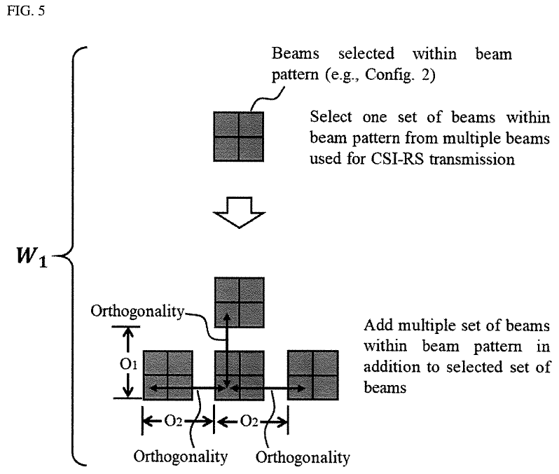

FIG. 5 is a diagram showing an example of W1 design for rank 2 according to one or more embodiments of the present invention.

In FIG. 5, each single grid represents one 2-Dimension (2-D) Discrete Fourier Transform (DFT) vector. The DFT vector constitutes the pre-coder used for beamforming. For example, if a beam is at a distance of [n1*O₁, n2*O₂] (n1=0, 1, 2, . . . N1−1, n2=0, 1, 2, . . . N2−1, where at least one of n1 or n2 is non-zero, here [X, Y] represents the distance in a first dimension (vertical direction) is X and in a second dimension (horizontal direction) is Y) from a reference beam, it is orthogonal to the reference beam. O represents a oversampling factor. O₁ represents an oversampling factor in a first dimension of a 2-dimension (2-D) array. O₂ represents an oversampling factor in a second dimension of a 2-D array. N1 represents an antenna ports number in the first dimension. N2 represents an antenna ports number in the second dimension. Furthermore, the first dimension and the second dimension may be replaced each other. For example, O₁ may be used to represent the second dimension (horizontal dimension), while O₂ may be used to represent the first dimension (vertical dimension). For example, N1 and N2 may represent the antenna ports numbers in the second dimension and the first dimension, respectively.

As shown in FIG. 5, by W1, a set of beams may be selected within the beam pattern (e.g., Config. 2) from multiple beams used for the CSI-RSs transmission. For layer 1 and layer 2, in Configs. 2-4, 4 beams may be selected from all of the beams used of the CSI-RSs transmission and beam spacing is 1. Thus, the W1 indicates a plurality of sets of the beams in each of the layers 1 and 2. The plurality of sets of the beams adjacent to each other are orthogonal. Furthermore, the number of beam patterns according to one or more embodiments is not limited to four (Configs. 1-4). The number of beam patterns may be a predetermined number which is at least one.

Then, by W1, one or more sets of beams may be added in addition to the selected set of beams. A predetermined reference beam and beams disposed at a distance of [n1*O₁, n2*O₂] are orthogonal to each other. In an example of FIG. 5, a distance between a predetermined reference beam and beams orthogonal thereto is [O₁, 0] or [0, O₂], or [0, (N₂−1)O₂]. In one or more embodiments, a plurality of sets of beams include the one or more sets of beams and the selected set of beams.

As shown in FIG. 5, W1 includes 16 beams in the pattern in total. In addition to beams in the Config. 2 beam pattern, the beam pattern also includes beams that are orthogonal to the beams. W1 can be represent as:

$${W}_{1} = [ \begin{matrix}{b}_{1} {b}_{2} … {b}_{16} & 0 \\ 0 & {b}_{1} {b}_{2 } … {b}_{16}\end{matrix} ] ,$$

where bᵢ represents one DFT vector.

In one or more embodiments, in W2 for the layer 1, one beam may be used within the beam pattern.

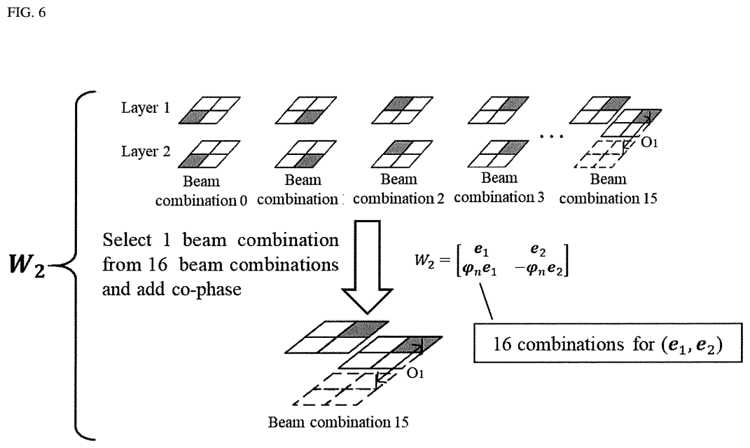

On the other hand, as shown in FIG. 6, in W2 for the layer 2, one beam combination of beams in the layers 1 and 2 may be selected from all of beam combinations. All of the beam combinations may be determined based on a plurality of sets of beams determined by W1. In one or more embodiments, the combination of beams may be a pair of the same beams in the layers 1 and 2. The same beams between the layers 1 and 2 may be disposed at the same location in the first and second dimensions within the beam pattern. Furthermore, the same beams may be orthogonal to each other. Thus, the W2 indicates a combination of the same beams between the layers 1 and 2.

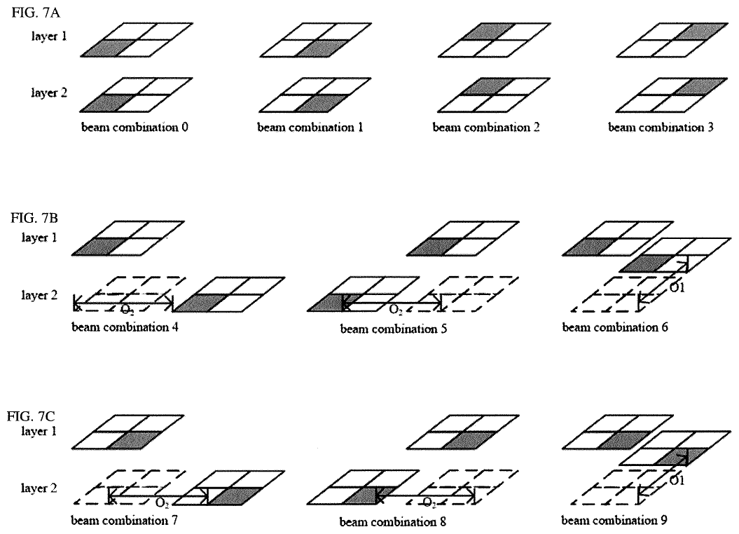

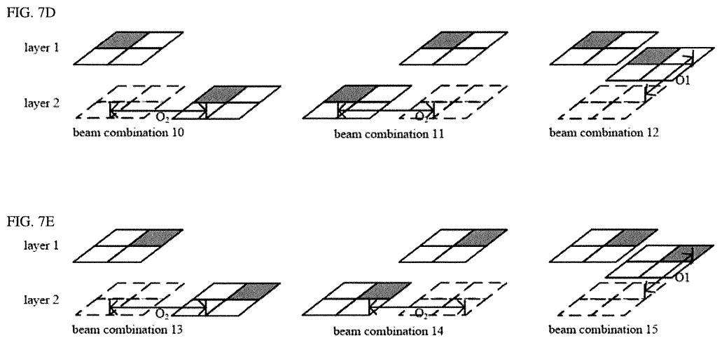

FIGS. 7A-7E are diagrams showing examples of all of beam combinations for W2 for beam selection according to one or more embodiments of the present invention. As shown in FIGS. 7A-7E, a beam combination consists of a beam in the layer 1 and a beam in the layer 2 disposed at the same location within the beam pattern as the beam in the layer 1. For example, FIG. 7A shows beam combination 0 that consists of a a bottom left beam in Config. 2 in the layer 1 and a bottom left beam in Config. 2 in the layer 2. FIG. 7B shows beam combinations 4-6 that consists of the bottom left beam in Config. 2 in the layer 1 and each bottom left beam in Config. 2 in the layer 2 disposed at [0, O₂], [0, −O₂], or [O₁, 0]. Thus, for W2 design, the total number of beam combinations is 16.

In an example of FIG. 6, beam combination 15 is selected from 16 beam combinations. W2 may be indicates as

$${W}_{2} = [ \begin{matrix}{e}_{1} & {e}_{2} \\ {ϕ}_{n} {e}_{1} & - {ϕ}_{n} {e}_{2}\end{matrix} ] ,$$

where the combination of (e₁, e₂) are predefined. eᵢ is unit vector and φₙ is the co-phase between two polarizations. Further, by W2, co-phase between two polarizations for each of the layers 1 and 2 may be added.

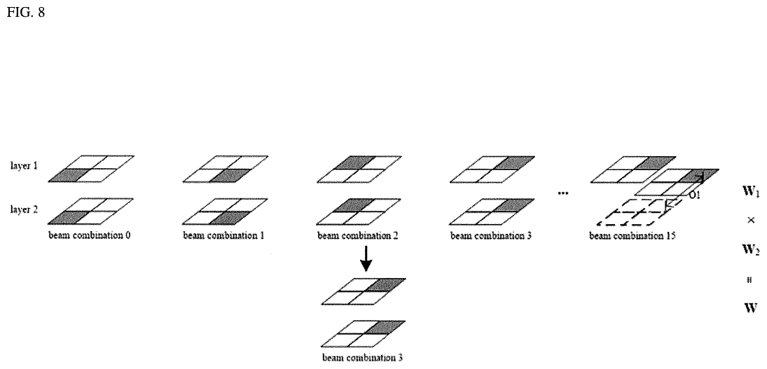

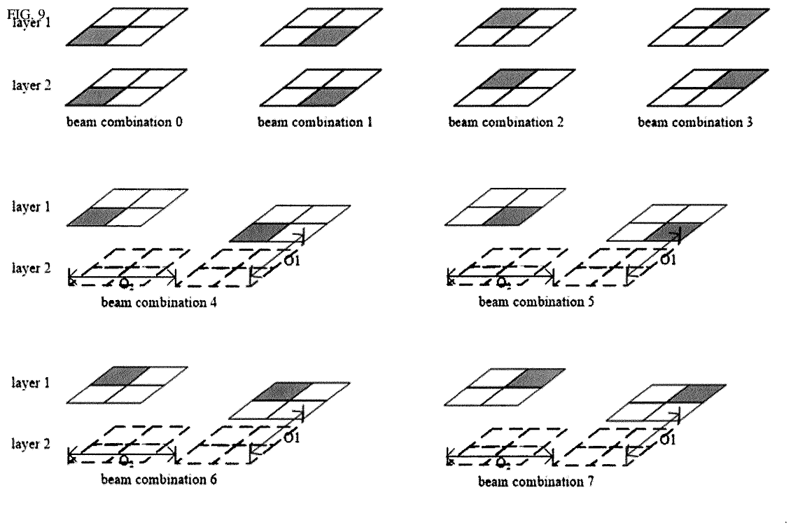

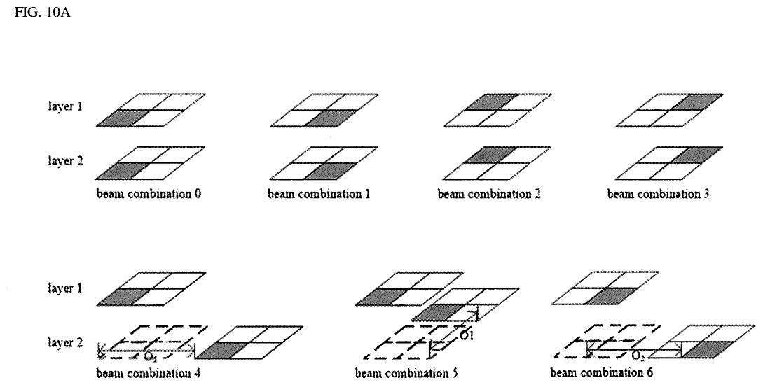

FIG. 8 is a diagram showing an example of beam combination selection by W1W2 according to one or more embodiments of the present invention. By W=W1W2, a precoder for rank 2 can be acquired. For example, as shown in FIG. 8, W2 may select one combination from 16 combinations, constituting a final precoder used for beamforming.

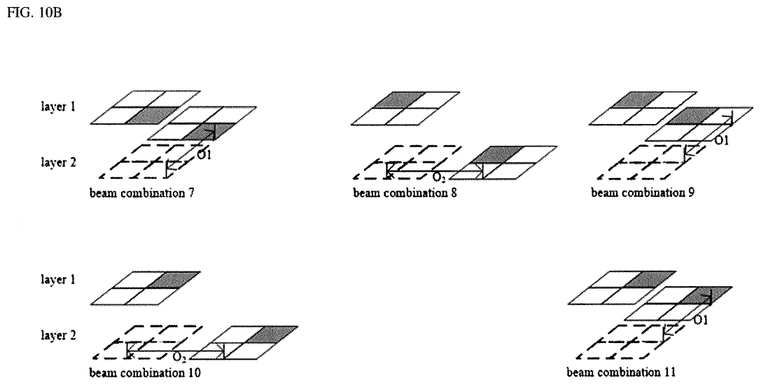

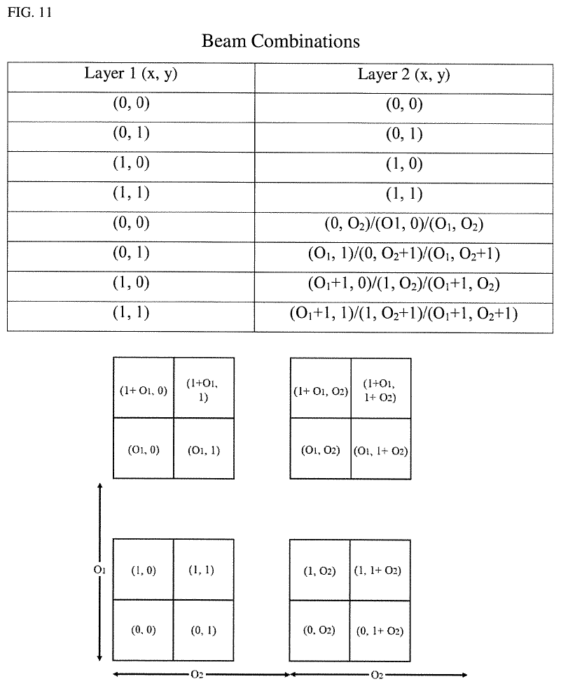

Depending on different deployment scenarios, the beams in W1 can be changed, and beams in W1 can be reduced to number 8 or increased to number 20. FIG. 9 is a diagram showing an example of 8 beams in W1 and 8 combinations for W2 for selection according to one or more embodiments of the present invention. FIGS. 10A and 10B are diagrams showing examples of 12 beams in W1 and 12 combinations for W2 for selection according to one or more embodiments of the present invention. In FIGS. 9, 10A and 10B, other beam combination examples are illustrated. In FIG. 9, there are 8 beams in W1 and 8 beam combinations in total. In FIGS. 10A and 10B, there are 12 beams in W1 and 12 beam combinations in total. In addition to the example illustrated in FIGS. 7A-7E, 9, 10A, and 10B, W1 can involve all the beams in FIGS. 7A-7E, 8, and 9, in that case, there are 20 beams total, and the beam combinations number may be 20.

FIG. 11 is a diagram showing an example of beam combinations according to one or more embodiments of the present invention. The beam pattern for the beam combinations of FIG. 11 may be Config. 2. In FIG. 11, a position of each beam is denoted as (x, y), where x is a position in a first dimension (vertical direction) and y is a second dimension (horizontal direction). Each position of the beam in FIG. 11 corresponds to a coordinate of FIG. 11.

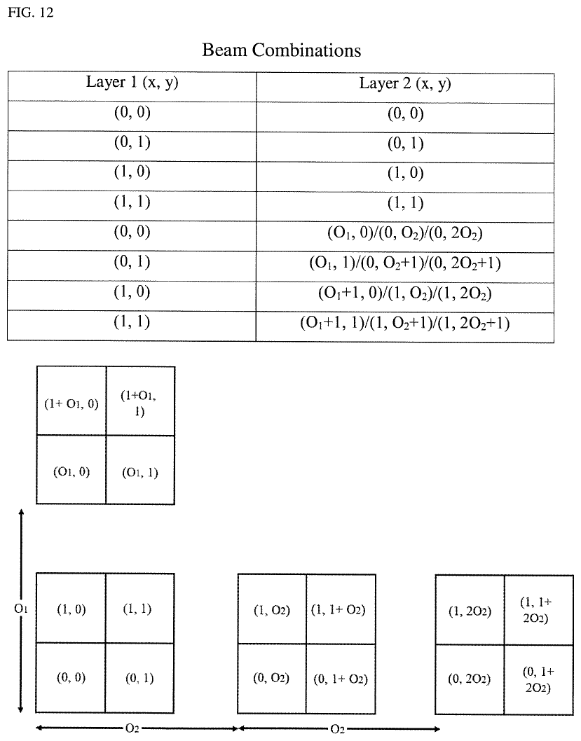

FIG. 12 is a diagram showing another example of beam combinations according to one or more embodiments of the present invention. Each position of the beam in FIG. 12 corresponds to a coordinate of FIG. 12.

In one or more embodiments, an overhead of W1 may be ┌log₂(N₁×O₁/S₁)┐+┌log₂(N₂×O₂/S₂)┐ bits, where N₁ and N₂ are the antenna port number in two dimensions, O₁ and O₂ are the oversampling factors for two dimensions, and S₁ and S₂ are the spacing between two beam groups. On the other hand, an overhead of W1 may be 5 bits, which consists of 2 bits for beam selection within the beam pattern, 2 bits for beam combination selection among all the combinations for the beam selected within 4 beams, and 1 bit for co-phase selection. According to one or more embodiments, orthogonality between layers 1 and 2 may be better than conventional scheme.

Subband and wideband beams selection schemes for rank 2 codebook according to one or more embodiments will be described below.

The subband beam selection scheme may apply the W1 design in FIG. 5 and the W2 design in FIG. 6. Further, for subband beam combination selection, W2 needs 5 bits.

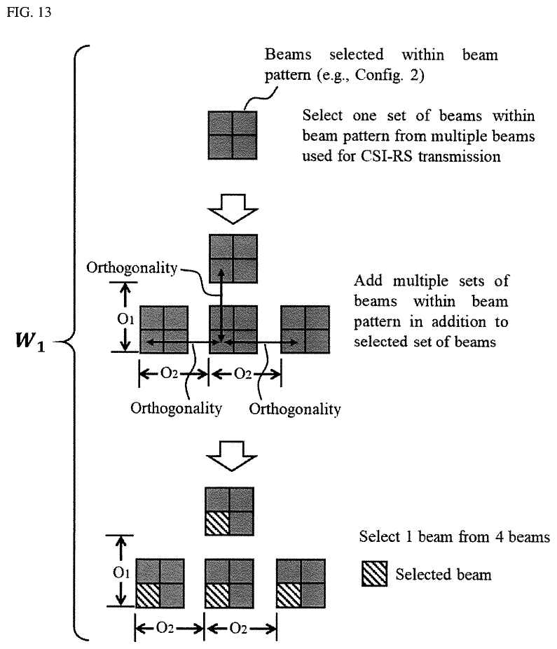

On the other hand, in the wideband beam selection scheme, in W1, one beam may be further selected. As shown in FIG. 13, after multiple sets of beams within the beam pattern are added, 1 beam may be further selected from 4 beams within the beam pattern in each set of beams. For example, by W1, one beam in each set of beams may be further selected from beams of (0,0), (0,1), (1,0), (1,1).

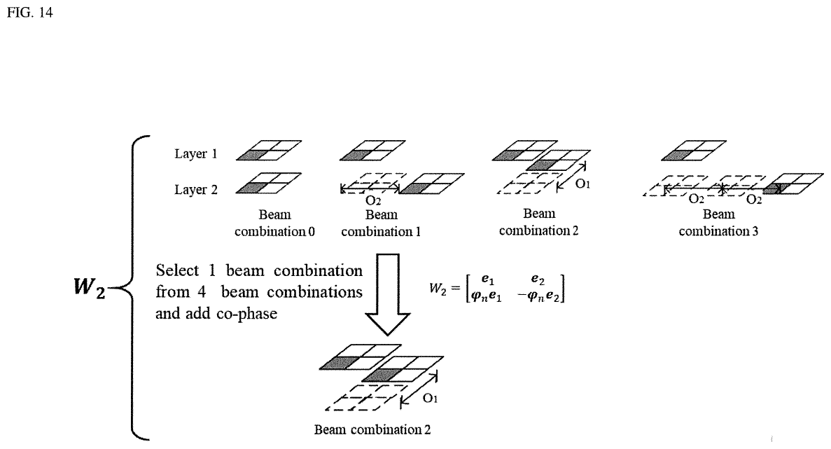

Then, by W2, as shown in FIG. 14, 1 beam combination may be selected from 4 beam combinations and co-phase may be added. In an example of FIG. 14, beam combination 2 may be selected from beam combinations 0-4. For example, beams in the layer 2 of the beam combinations may be beams of (0,0), (0,O2), (O1,0), (0,2O2). Further, W2 needs 3 bits.

One or more embodiments of the present invention is related to codebook design for NR Type I CSI, rank 2. The orthogonal beams in W1 beam pattern design according to one or more embodiments of the present invention may be an extension from legacy schemes. One or more embodiments may define the beam combinations for W2 selection. By performing W1W2, the precoder for rank 2 may include two orthogonal beams for each layer. As a result, the orthogonality between layers can be improved, thus reducing the inter layer interference.

For W1 design, the beam number in a conventional scheme is 4. On the other hand, according to one or more embodiments of the present invention, the beam number for enhanced scheme may be 16. From feedback point of view, the overhead for W1 stays the same as the overhead for legacy schemes.

For W2 design, the beam combination number in conventional scheme is 8. On the other hand, according to one or more embodiments of the present invention, the beam combination number for enhanced scheme is 16 if three pairs of orthogonal beams are defined. From feedback point of view, the overhead for W2 need one more bit than the legacy scheme. However, depending on different deployment scenarios, different numbers of orthogonal beam pairs can be defined, leading to different overhead values.

For example, one or more embodiments of the present invention may be used for the BS 20 such as gNB to optimize beamforming and Multiple-Input and Multiple-Output (MIMO) (e.g., Single User (SU)-MIMO or Multi User (MU)-MIMO) to provide better orthogonality between layers.

For example, in one or more embodiments of the present invention, N1 and N2 may be replaced each other and O1 and O2 may be replaced each other.

One or more embodiments of the present invention relate to a method of orthogonal beam selection in the beam pattern in addition to the beams that are adjacent (beam spacing is 1). As a result, the orthogonality between layers can be improved, thus reducing interference between layers.

In accordance with one or more embodiments of the present invention, beams in a beam pattern for W₁ design include beams in LTE rank 2 beam pattern. The beams in the beam pattern for W₁ design may be orthogonal to the beams within the beam pattern in LTE.

In accordance with one or more embodiments of the present invention, beams for two layers for W₂ design may be the same, by adding fixed co-phase in second polarization for two layers, e.g., 1 for layer 1 and −1 for layer 2 (QPSK), or 1/\sqrt{2}(1+j) for layer 1 and 1/\sqrt{2}(−1−j) for layer 2 (8-PSK), the beams for two layers are orthogonal. In addition, the beams for two layers for each polarization can also be orthogonal. As a result, the orthogonality between layers can be improved.

One or more embodiments of the present invention relate to orthogonal beams in beam pattern design for W1 and a layer 2 beam combination in which beams in one beam combination may be orthogonal. As a result, the orthogonality between layers can be improved, thus reducing inter layer interference.

(Configuration of Base Station)

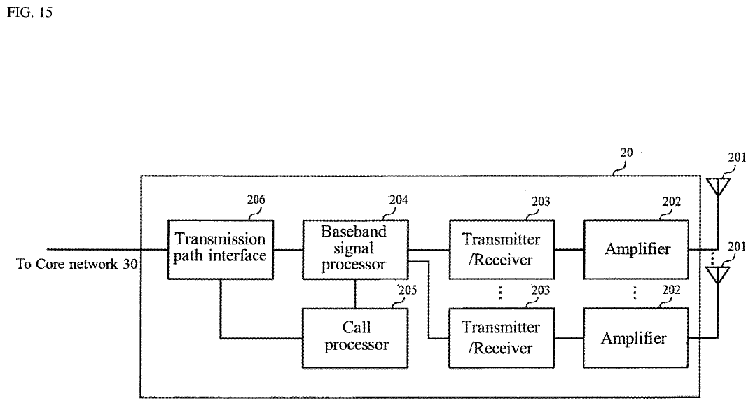

The BS 20 according to one or more embodiments of the present invention will be described below with reference to FIG. 15. FIG. 15 is a diagram illustrating a schematic configuration of the BS 20 according to one or more embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

(Configuration of User Equipment)

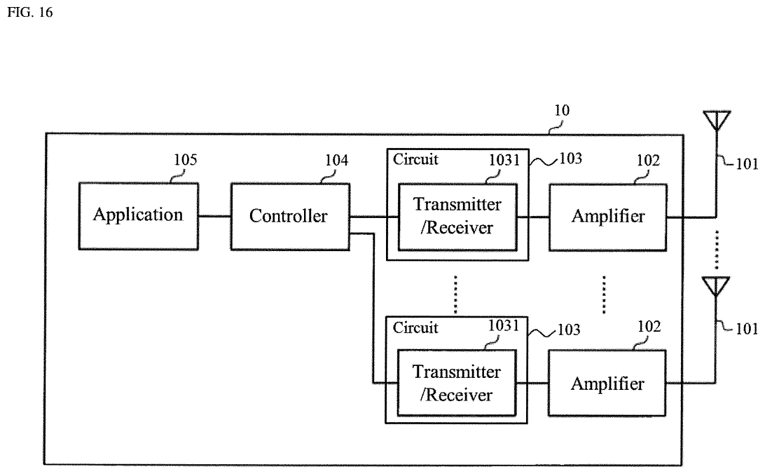

The UE 10 according to one or more embodiments of the present invention will be described below with reference to FIG. 16. FIG. 16 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

### Another Example

Although the present disclosure mainly described examples of a channel and signaling scheme based on NR, the present invention is not limited thereto. One or more embodiments of the present invention may apply to another channel and signaling scheme having the same functions as LTE/LTE-A and a newly defined channel and signaling scheme.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (UE) in a in a wireless communication system, comprising:
a receiver that receives, from a base station (BS), Channel State Information-Reference Signals (CSI-RSs) using a plurality of first beams;
a processor that:
selects a first matrix W1 from a first codebook and a second matrix W2 from a second codebook; and
selects second beams from the plurality of first beams; and
a transmitter that performs CSI reporting that includes precoding matrix indicators (PMIs) corresponding to the W1 and W2,
wherein the W1 indicates a plurality of sets of the second beams in each of a first layer and a second layer,
wherein the plurality of sets adjacent to each other are orthogonal, and
wherein the W2 indicates a combination of same beams between the first layer and the second layer.

2. The UE according to claim 1,
wherein one of the same beams is selected from the second beams of the plurality of sets in the first layer, and
wherein the other of the same beams is selected from the second beams of the plurality of sets in the second layer.

3. The UE according to claim 1,
wherein the W1 indicates a third beam selected from the second beams in each of the plurality of sets, and
wherein the third beam in each of the plurality of sets is a same.

4. The UE according to claim 2,
wherein the W1 indicates a third beam selected from the second beams in each of the plurality of sets,
wherein the third beam in each of the plurality of sets is a same, and
wherein the same beam is the third beam.

5. The UE according to claim 1, wherein polarizations of the same beams are co-phased.

6. The UE according to claim 1, wherein the same beams are orthogonal to each other.

7. The UE according to claim 1, wherein the same beams are orthogonal to each other.
wherein the receiver receives, from the BS, codebook configuration information indicating a beam pattern that designates locations of beams, and
wherein the second beams are selected with in the beam pattern.

8. A base station (BS) in a in a wireless communication system, comprising:
a transmitter that transmits, to a user equipment (UE), Channel State Information-Reference Signals (CSI-RSs) using a plurality of first beams;
a receiver that receives CSI reporting that includes precoding matrix indicators (PMIs) corresponding to a first matrix W1 selected from a first codebook and a second matrix W2 selected from a second codebook the W1 and W2,
wherein the transmits a downlink signal precoded using the PMIs,
wherein the W1 indicates a plurality of sets of second beams in each of a first layer and a second layer,
wherein the second beams are selected from the plurality of first beams; and
wherein the plurality of sets adjacent to each other are orthogonal, and
wherein the W2 indicates a combination of same beams between the first layer and the second layer.

9. The BS according to claim 8,
wherein one of the same beams is selected from the second beams of the plurality of sets in the first layer, and
wherein the other of the same beams is selected from the second beams of the plurality of sets in the second layer.

10. The BS according to claim 8,
wherein the W1 indicates a third beam selected from the second beams in each of the plurality of sets, and
wherein the third beam in each of the plurality of sets is a same.

11. The BS according to claim 9,
wherein the W1 indicates a third beam selected from the second beams in each of the plurality of sets,
wherein the third beam in each of the plurality of sets is a same, and
wherein the same beam is the third beam.

12. The BS according to claim 8, wherein polarizations of the same beams are co-phased.

13. The BS according to claim 8, wherein the same beams are orthogonal to each other.

14. The BS according to claim 8, wherein the same beams are orthogonal to each other.
wherein the transmitter transmits, to the UE, codebook configuration information indicating a beam pattern that designates locations of beams, and
wherein the second beams are selected with in the beam pattern.
